(19) United States
(12) Patent Application Publication
(10) Pub. No.: US 2026/0299576 A1
(43) Pub. Date: Oct. 1, 2026

(54) METHOD AND SYSTEM FOR PERFORMING ROOT CAUSE ANALYSIS IN WAREHOUSE MANAGEMENT SYSTEM USING ARTIFICIAL INTELLIGENCE

(71) Applicant: Profitops Inc., Cumming, GA (US)

(72) Inventor: Shravan Talupula, Cumming, GA (US)

(73) Assignee: Profitops Inc., Cumming, GA (US)

(21) Appl. No.: 19/095,189

(22) Filed: Mar. 31, 2025

(51) Int. Cl. G05B 23/02

(52) U.S. Cl. CPC G05B 23/0275; G05B 23/0272

(57) ABSTRACT

A method and a system for performing root cause analysis in a warehouse management system using artificial intelligence is disclosed. The method involves receiving real-time binary data such as images, videos, and sensor data that depict warehouse process errors in real-time or from archived records. The system extracts contextual data from various warehouse databases, including package, picking, device, and environmental data. Using this data, an initial hypothesis for the error's root cause is generated through an AI model. The method constructs a directed acyclic graph (DAG) to map potential causal relationships among variables and applies statistical and machine learning techniques to identify and validate the root causes. The results are validated against historical data, improving the system's accuracy and efficiency in diagnosing operational errors.

### TECHNICAL FIELD

This disclosure relates generally to the field of warehouse management system, and more specifically to a method and system for performing root cause analysis in systems involved in operating a warehouse, including Warehouse Execution Systems (WES), and Warehouse Automation Systems (WAS) using artificial intelligence. For simplicity, these systems will collectively be referred to as Warehouse Management Systems (WMS) throughout his document.

### BACKGROUND

Warehouses play a crucial role in the modern supply chain, managing vast quantities of inventory and ensuring that products are stored, processed, and delivered on time. To manage these operations, many businesses rely on Warehouse Management Systems (WMS) that track inventory, process orders, and manage workflows in real time. While these systems have revolutionized warehouse operations by automating and optimizing certain tasks, they often fall short when it comes to diagnosing the root causes of operational issues. Problems such as mispacked orders, equipment malfunctions, and delayed shipments still require significant human intervention to identify, troubleshoot, and resolve. In fast-paced environments, where meeting customer expectations for speed and accuracy is critical, the inability to quickly diagnose and address these issues can lead to inefficiencies, delays, and increased costs.

Existing warehouse management systems are designed to manage data and processes but lack the capability to proactively analyse why things go wrong. This forces warehouse staff to react to problems after they have occurred, relying on manual oversight to figure out what went wrong and how to fix it. This reactive approach is not only slow but prone to human error, especially in high-pressure situations. With an increasing shortage of experts skilled in both operations and data analysis, many warehouses struggle to interpret their own data and make informed decisions. As a result, recurring operational disruptions lead to increased labor costs, missed Service Level Agreements (SLAs), and ultimately lower customer satisfaction. In a time where efficiency, accuracy, and speed are more important than ever, warehouses need smarter solutions that can anticipate issues and provide real-time insights to support smoother, more efficient operations.

Therefore, there is a need for a methodology for performing root cause analysis in warehouse management system using artificial intelligence.

### SUMMARY OF THE INVENTION

In an embodiment, a computer-implemented method for performing root cause analysis in a warehouse management system using artificial intelligence is disclosed. The method may include training, by a computing device, a generative artificial intelligence (AI) model by collecting, cleansing, unifying, annotating, and labelling binary data received by the computing device. In an embodiment, the binary data comprising one or more images, one or more videos, sensor data, and system data depicting a comprehensive data of both successful and error data in the warehouse. In an embodiment, the generative AI model is trained based on the labelled binary data. The method may further include receiving, by a computing device, real-time binary data comprising one or more images, one or more videos, and sensor-data depicting a process error in the warehouse. In an embodiment, the real-time binary data may be captured in real-time and/or from archived records. The method may further include extracting, by the computing device, contextual data related to the process error from one or more warehouse databases, trained/labelled data related to historical process execution comprising both success and error. In an embodiment, the contextual data may include package information, picking information, packing information, quality check information, device data, process data, human factors, environmental data, historical anomaly data, customer feedback data, and operator-captured screenshots and videos. The method may further include generating, by the computing device, an initial hypothesis for a root cause of the process error based on the real-time binary data and the contextual data using the generative AI model. The method may further include constructing, by the computing device, a directed acyclic graph (DAG) representing potential causal relationships among variables associated with the process error using a DAG generation module. In an embodiment, the DAG may capture both direct and indirect casual dependencies among the variables, which may be derived from the contextual data and historical trained data. The method may further include identifying, by the computing device, one or more root causes of the process error by applying statistical and machine learning and advanced Artificial Intelligence (AI) techniques to the DAG to estimate strength and direction of causal relationships between the variables associated with the process error, using a structured causal model. The method may further include validating, by the computing device, the identified root causes by comparing results of the structured causal model against historical data and known outcomes.

In another embodiment, a computer-implemented system for performing root cause analysis in a warehouse management system using artificial intelligence is disclosed. The system may include a computing device that may include a processor and a memory communicably coupled to the processor. In an embodiment, the memory stores processor-executable instructions, which when executed by the processor, cause the processor to train a generative artificial intelligence (AI) model by collecting, cleansing, unifying, annotating, and labelling binary data received by the computing device, wherein the binary data comprising one or more images, one or more videos, sensor data, and system data depicting a comprehensive data of both successful and error data in the warehouse. In an embodiment, the generative AI model is trained based on the labelled binary data. The processor may further receive real-time binary data comprising one or more images, one or more videos, and sensor-data depicting a process error in the warehouse. In an embodiment, the real-time binary data may be captured in real-time and/or from archived records. The processor may further extract contextual data related to the process error from one or more warehouse databases, trained/labelled data related to historical process execution comprising both success and error. In an embodiment, the contextual data may include package information, picking information, packing information, quality check information, device data, process data, human factors, environmental data, historical anomaly data, customer feedback data, and operator-captured screenshots and videos. The processor may further include generate an initial hypothesis for a root cause of the process error based on the real-time binary data and the contextual data using a generative AI model. The processor may further construct a directed acyclic graph (DAG) representing potential causal relationships among variables associated with the process error using a DAG generation module. In an embodiment, the variables are derived from the contextual data and historical trained data. In an embodiment, the DAG captures both direct and indirect causal dependencies among the variables, which are derived from the contextual data. The processor may further identify one or more root causes of the process error by applying statistical and machine learning and advanced Artificial Intelligence (AI) techniques to the DAG to estimate strength and direction of causal relationships between the variables associated with the process error, using a structured causal model. The processor may further validate the identified root causes by comparing results of the structured causal model against historical data and known outcomes.

It is to be understood that both the foregoing general description and the following detailed description are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 is a block diagram of an exemplary computer-implemented system 100 for performing root cause analysis in a warehouse management system, in accordance with an embodiment of the present disclosure.

FIG. 2 illustrates a functional block diagram of various modules within a memory of a computing device of FIG. 1, configured to perform root cause analysis in a warehouse management system, in accordance with an embodiment of the present disclosure.

FIG. 3A and FIG. 3B is a flow diagram of a methodology for performing root cause analysis in a warehouse management system, in accordance with an embodiment of present disclosure.

FIG. 4 is a detailed flow diagram of a methodology for performing root cause analysis in a warehouse management system, in accordance with an exemplary embodiment of present disclosure.

FIG. 5 illustrates an exemplary computer system for implementation of a method for performing root cause analysis in a warehouse management system, in accordance with an exemplary embodiment of present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

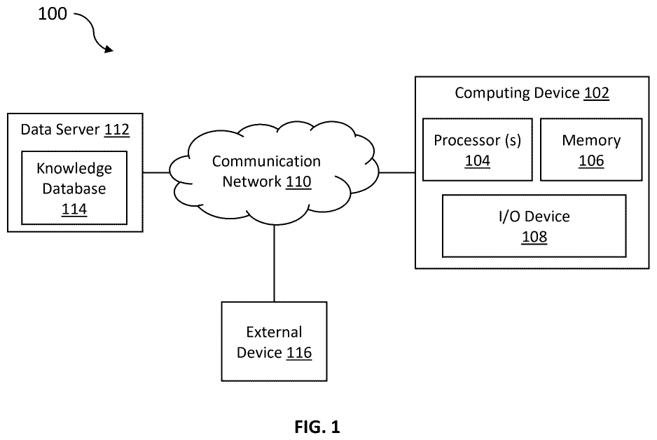

Referring now to FIG. 1, an exemplary computer-implemented system 100 for performing root cause analysis in a warehouse management system, in accordance with an embodiment of the present disclosure. The system 100 may include a computing device 102, a data server 112, and an external device 116 communicably coupled to each other through a wired or wireless communication network 110. The computing device 102 may include a processor 104, a memory 106 and an input/output (I/O) device 108.

In an embodiment, processor(s) 104 may include but are not limited to, microcontrollers, microprocessors, digital signal processors (DSPs), application-specific integrated circuits (ASICs), field-programmable gate arrays (FPGAs), system-on-chip (SoC) components, or any other suitable programmable logic devices. Examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors.

In an embodiment, the memory 106 may store instructions that, when executed by the processor 104, and cause the processor 104 to perform root cause analysis in the warehouse management system, as will be discussed in greater detail herein below. In an embodiment, the memory 106 may be a non-volatile memory or a volatile memory. In an embodiment, the memory 106 may also store a single module or a combination of different modules to perform root cause analysis in the warehouse management system. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 112 may be enabled in a remote cloud server or a co-located server and may include a knowledge database 114 to store data necessary for the system 100. In an embodiment, the data server 112 may store data input by the external device 116 or output generated by the computing device 102. In an embodiment, the computing device 102 may be communicably coupled with the data server 112 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), or a Metropolitan Area Network (MAN). Various devices in the system 100 may be configured to connect to the communication network 110, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. Further the communication network 110 can include a variety of network devices, including routers, bridges, servers, computing devices, storage devices, and the like.

In an embodiment, the computing device 102 may receive a set of user instructions from the external device 116 through the communication network 110. In an embodiment, the computing device 102 and the external device 116 may be a computing system, including but not limited to, a laptop computer, a desktop computer, a notebook, a workstation, a server, a portable computer, a handheld or a mobile device. In an embodiment, the computing device 102 may be, but not limited to, in-built into the external device 116 or may be a standalone computing device.

In an embodiment, the computing device 102 may perform various processing in order to perform root cause analysis in a warehouse management system. By way of an example, the computing device 102 may train a generative artificial intelligence (AI) model by collecting, cleansing, unifying, annotating, and labelling binary data received by the computing device 102. In an embodiment, the binary data comprising one or more images, one or more videos, sensor data, and system data depicting a comprehensive data of both successful and error data in the warehouse. In an embodiment, the generative AI model is trained based on the labelled binary data. The computing device 102 may further receive real-time binary data that may include one or more images, one or more videos, and sensor-data depicting a process error in the warehouse. In an embodiment, the real-time binary data may also include error screenshots and videos captured by the warehouse operator or warehouse device. In an embodiment, the real-time binary data may be captured in real-time and/or from archived records. The computing device 102 may further extract contextual data related to the process error from one or more warehouse databases. In an embodiment, the contextual data may include but not limited to package information, picking information, device data, process data, human factors, environmental data, historical anomaly data, customer feedback data, and operator-captured screenshots, videos, and upstream, midstream and downstream system data. In an embodiment, the contextual data may include but not limited to customer feedback data, including customer complaints, reasons, and customer satisfaction scores. The package information may include but not limited to package ID, SKU, weight, and destination. The picking information may include but not limited to picker ID, bin location, picked quantity, and pick status. The device data may include device type, device ID, device status, and error logs. The process data may include expected and actual values at each process step, cycle time and resolution action taken. The human factors may include operator ID, experience level, shift ID, and staffing level. The environmental data may include temperature, humidity, and warehouse traffic levels.

The computing device 102 may further generate an initial hypothesis for a root cause of the process error based on the real-time binary data and the contextual data using a generative artificial intelligence (AI) model. The computing device 102 may further construct a directed acyclic graph (DAG) representing potential causal relationships among variables associated with the process error using a DAG generation module. In an embodiment, the variables are derived from the contextual, trained and historical data. In an embodiment, the DAG captures both direct and indirect causal dependencies among the variables, which are derived from the contextual, trained and historical data. In an embodiment, the DAG generation module constructs the directed acyclic graph by combining manual input from the subject matter expert with automated discovery algorithms.

The computing device 102 may further identify one or more root causes of the process error by applying statistical and machine learning techniques to the DAG to estimate strength and direction of causal relationships between the variables associated with the process error, using a structural causal model. The computing device 102 may further validate the identified root causes by comparing results of the structured causal model against trained historical data and known outcomes.

The computing device 102 may further display via the I/O device 108, the one or more root causes to a warehouse operator for review and feedback. The computing device 102 may further receive operator input indicating acceptance or rejection of each presented root cause. The computing device 102 may further refine the structured causal model based on the feedback received from the operator using a reinforcement learning module. In an embodiment, positive feedback reinforces the accuracy of identified root causes and negative feedback triggers model adjustments. In an embodiment, the reinforcement learning module uses a reward-based mechanism to adjust the parameters of the structured causal model. In an embodiment, positive rewards may be assigned to accepted root causes and negative may be assigned to rejected root causes.

The computing device 102 may further store the operator input, and a corresponding reasoning in the knowledge database 114. In an embodiment, the knowledge database 114 may be used for future predictions and analysis. In an embodiment, the knowledge database 114 may store a history of success, errors, accepted root causes, rejected root causes, and model refinements. The computing device 102 may further generate an error report summarizing the root causes, operator feedback, and model adjustments for review by a warehouse management team. The computing device 102 may further recommend corrective actions to the warehouse operator based on the identified root causes, the trained data, and the historical data stored in the knowledge database 114.

In an exemplary scenario, a warehouse worker which could be a human or a robot, using a barcode scanner, scans a package at the weighing station. The computing device 102 detects that the actual weight of the package is significantly different from the expected weight. This discrepancy triggers an error alert in the warehouse management system. Upon receiving the error alert, the computing device 102 automatically collects various types of data to begin the root cause analysis. These data include real-time binary data such as a real-time image of the package, showing its contents and a short video recorded by the weighing device, depicting the scanning and weighing process. The data also includes the contextual data. The contextual data include, but not limited to, Package Information such as package ID, expected and actual weights, the SKU (stock-keeping unit), and the package destination; Picking Information such as picker ID, the quantity picked, and the bin location from where the items were selected; Device Data such as information about the weighing device, such as device type, ID, and logs of any device malfunctions; and upstream, midstream and downstream systems data, Process Data such as expected weight vs. actual weight at the weighing station, along with the time taken to weigh the package; Human Factors such as operator ID, their experience level, and the current staffing level; and Environmental Data such as Temperature and humidity conditions in the warehouse, which could affect the scale's accuracy. This data is sourced from both real-time feeds and historical warehouse databases, stored on the data server 112 with the knowledge database 114. The external device 116, which might be a handheld scanner or a workstation, communicates with the computing device to feed it real-time information. Once the data is collected, the processor 104 in the computing device 102 executes AI-based algorithms stored in the memory 106. The computing device 102 then generates an initial hypothesis using the real-time binary data (images and videos) and contextual data to identify what might have caused the error. For example, it hypothesizes that either a picking error (wrong item picked) might be the root cause.

Next, the computing device 102 constructs a Directed Acyclic Graph (DAG), which maps out all potential causal relationships between the variables involved in the process. This may include, but not limited to, relationships between: Device performance (e.g., whether the scale was recently calibrated), Picking errors (e.g., the actual vs. expected item quantity), Environmental conditions (e.g., temperature affecting device accuracy), and Human factors (e.g., an inexperienced worker operating the scale).

This graph is built using both manual input from the subject matter expert (who might suggest potential causes) and automated discovery algorithms run by the computing device 102. The computing device 102 applies statistical and machine learning techniques to the DAG to evaluate the strength of causal links. It identifies one or more likely root causes for the error. In this case, the analysis reveals that the warehouse operator which picked the item is substituted with the alternative item which had different dimensions, causing it to the mismatch of the package weight. Additionally, the wrong item was picked from the bin, which also contributed to the mismatch.

The computing device 102 displays the identified root causes on an interface (through the I/O device 108), allowing the warehouse operator to review the findings. The operator confirms that the scale indeed showed incorrect readings and that a picking error occurred, corroborating the system's findings. The operator's feedback is fed back into the computing device 102. Since the operator confirmed the root causes, the system's reinforcement learning module assigns positive rewards to these findings. This feedback helps the AI model improve its accuracy for future analyses. If the operator had disagreed, the computing device 102 would have adjusted its model to better handle similar situations in the future. The computing device 102 stores this entire process, including the identified root causes, operator feedback, and model adjustments, in the knowledge database 114. This data can be used for future predictions and RCA processes, allowing the computing device 102 to learn from past mistakes and improve over time.

Finally, the computing device 102 generates a detailed error report, summarizing the root causes, operator feedback, and the reinforcement learning adjustments made. Based on this, the computing device 102 recommends corrective actions, such as recalibrating the scale and retraining staff on proper picking procedures. The report is then reviewed by the warehouse management team, who can use it to implement the recommended actions, ensuring that the same error is less likely to occur in the future.

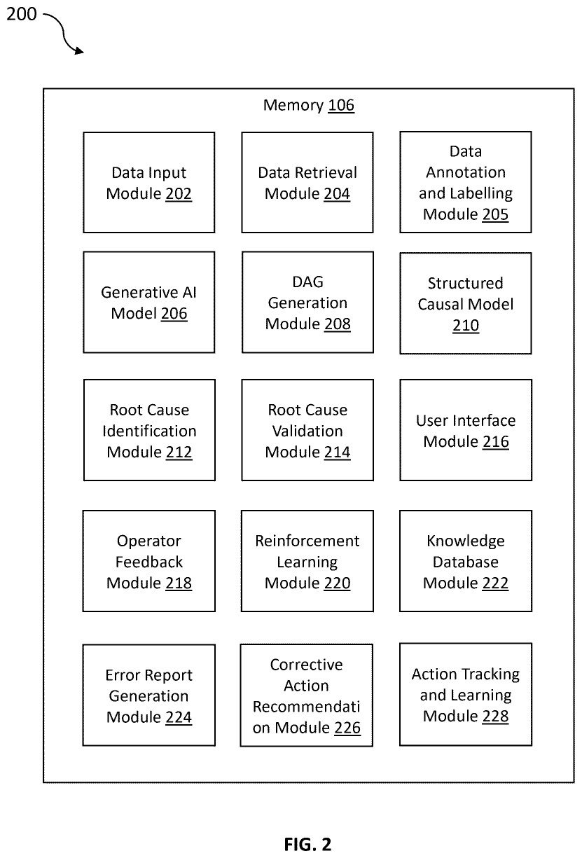

Referring now to FIG. 2, a functional block diagram 200 of various modules within the memory 106 of the computing device 102 of FIG. 1, configured to perform root cause analysis in the warehouse management system, is illustrated, in accordance with an embodiment of the present disclosure. The memory 106 may include a data input module 202, a data retrieval module 204, a data annotation & labelling module 205, a generative AI model 206, a DAG generation module 208, a structure causal model 210, a root cause identification module 212, a root cause validation module 214, a user interface module 216, an operator feedback module 218, a reinforcement learning module 220, a knowledge database module 222, an error report generation module 224, and a corrective action recommendation module 226, and action tracking and learning module 228.

The data input module 202 may receive real-time binary data that may include one or more images, one or more videos, and sensor-data depicting a process error in the warehouse management system (WMS). The real-time binary data may be sourced from various operational aspects of the WMS, such as receiving, put-away, picking, packing, and inventory management. In one embodiment, the real-time binary data may also include error screenshots and videos captured directly by the warehouse operator, enabling the system 100 to capture human observations of process anomalies. The data input module 202 may receive this real-time binary data in real-time as errors occur during warehouse operations, allowing for immediate analysis. Additionally, archived records may also be utilized, enabling the system 100 to access historical data for more comprehensive root cause analysis. Each real-time binary data input is labelled with specific categories and attributes to create a structured training dataset, which may include metadata such as timestamps, process identifiers, and the type of error observed. This structured data is critical for training machine learning models to accurately analyse and diagnose process errors within the WMS.

The data retrieval module 204 may further extract contextual data related to the process error from one or more warehouse databases. This contextual data is sourced from a variety of systems and devices within the warehouse, including warehouse management systems (WMS), warehouse control systems (WCS), warehouse automation systems (WAS), and related platforms. The extracted data encompasses multiple formats, including structured, unstructured, semi-structured, and real-time binary data types such as logs, screenshots, images, and sensor outputs. The contextual data provides a comprehensive view of both successful operations and errors, covering key warehouse processes such as picking, inventory control, and packing. In one embodiment, the contextual data includes package-specific information, such as package ID, SKU, weight, and destination. It also includes picking information like picker ID, bin location, picked quantity, and pick status. Device data may consist of device type, device ID, device status, and error logs. Process data captures expected and actual values at each operational step, along with cycle time and resolution actions taken. Additionally, human factors such as operator ID, experience level, shift ID, and staffing level may be collected. Environmental data, such as temperature, humidity, and warehouse traffic levels, is also extracted to provide further context on the operational conditions at the time of the error.

In an exemplary embodiment of the warehouse management system's root cause analysis (RCA) framework, the data input module 202 and the data retrieval module 204 are crucial components responsible for acquiring and organizing the necessary data to fuel the system's analysis processes. These modules are designed to handle vast and varied datasets from different sources and ensure they are properly structured for subsequent causal analysis, model refinement, and process optimization. The data input module 202 is responsible for collecting and processing data from multiple sources, including warehouse operations, devices, and environmental sensors. The data input module 202 gathers raw data that is essential for detecting process errors, performing root cause analysis, and improving system performance over time.

The data input module 202 collects structured, semi-structured, unstructured, and real-time binary data. This includes: Real-time binary data such as images or videos uploaded by the warehouse operator, which serve as the initial point of reference for identifying errors; Process Data like cycle times, expected versus actual values at each warehouse step, and overall process performance; Device Data, including device status, error logs, and timestamps, which are crucial for identifying potential equipment-related issues; and Environmental Data, such as warehouse temperature and humidity, which can influence both equipment performance and human error rates. The data input module 202 handles various formats, such as text-based logs, CSV data, binary files (e.g., images or videos), and real-time sensor outputs. This versatility ensures that all aspects of the warehouse process are captured for analysis. Once the raw data is collected, the data input module 202 performs an initial organization, labelling the data with relevant tags such as timestamps, process IDs, device statuses, and package or SKU identifiers. This categorization allows for easier retrieval and processing in later stages of the RCA framework. The data input module 202 can handle both real-time data (e.g., device error logs or process deviations as they occur) and historical data, which is essential for retrospective analysis and long-term model refinement.

The data retrieval module 204 is responsible for fetching specific data from the system's databases or external sources based on the context of the detected error or anomaly. The data retrieval module 204 plays a pivotal role in ensuring that the system 100 has access to the relevant information needed to conduct an accurate root cause analysis. When an error is detected, the system 100 initiates the retrieval process by querying the data retrieval module 204 for relevant data. For example, if an operator uploads a screenshot of an error message, the module fetches the related package information, device logs, and process data that occurred around the time of the error. This allows the system 100 to pinpoint when and where the error occurred and start tracing potential causes.

The data retrieval module 204 aggregates data from different systems and sources, such as: Package Information such as package IDs, SKUs, order IDs, and weight discrepancies; Picking Information relevant to errors in item selection or inventory management, such as under picking or over picking events; Device Information such as device logs and status reports that help detect equipment malfunctions or operational errors; and Environmental and Human Factors such as data related to warehouse conditions (e.g., temperature, humidity) and human operators (e.g., staffing levels, operator IDs). Not all available data may be relevant for every error. The data retrieval module 204 employs filters and contextual algorithms to ensure only pertinent information is retrieved based on the type of error or anomaly being analyzed. For instance, if the system 100 is analyzing a package weight discrepancy, the module focuses on retrieving weight measurements, SKU data, and device logs from scales, instead of fetching irrelevant picking information.

Together, the data input module 202 and data retrieval module 204 form the backbone of the RCA system's data collection and processing capabilities. The data input module 202 ensures that all relevant data is captured and structured, while the data retrieval module 204 ensures the right data is fetched when needed.

The data annotation & labelling module 205 is a critical component within the system 100, designed to process and prepare raw data for effective machine learning and root cause analysis (RCA). This data annotation & labelling module 205 focuses on adding context and structure to the data collected by the data input module 202 and the data retrieval module 204. This data annotation & labelling module 205 preprocesses raw real-time binary data (images, videos, logs, etc.) by cleaning, organizing, and normalizing it. This ensures consistency across datasets from various sources, such as warehouse management systems (WMS), sensors, and operator-uploaded screenshots. Duplicate or irrelevant data is removed, and incomplete entries are flagged for review or further processing. Each data point is annotated with metadata such as timestamps, operator IDs, device statuses, environmental conditions, and error classifications. For example, an image of a mislabeled package might be tagged with attributes like “Label Error,” “Packing Process,” and “Timestamp: 2024-12-21 10:30 AM.” Attributes relevant to causal analysis, such as whether a device malfunction contributed to the error or whether human error occurred, are explicitly tagged.

Data is categorized based on warehouse processes such as picking, packing, inventory management, and put-away. Errors are further classified into specific types, like “Overpicked,” “Mislabelled,” or “Device Malfunction.” This structured categorization allows the AI models to quickly identify patterns and trends during training. Annotated and categorized data is compiled into training, validation, and test datasets for machine learning models, ensuring high-quality input for model development. The data annotation & labelling module 205 labels both “success scenarios” (where operations run smoothly) and “error scenarios” (where anomalies occur), providing a balanced dataset for AI training. The data annotation & labelling module 205 validates the annotated data to ensure accuracy and consistency. Errors in labelling or annotation are flagged and corrected before being used in downstream processes. This step ensures that the generative AI model 206 and other analytical components receive high-quality input data for RCA. The generative artificial intelligence (AI) model 206 may further generate an initial hypothesis for a root cause of the process error based on the real-time binary data and the contextual data. This process begins with training the generative AI model 206 on the multi-source, multi-format data collected from the warehouse, which includes images, videos, logs, and sensor data across different processes such as picking, packing, and inventory management. Prior to training, the data undergoes preprocessing, including cleaning, normalization, and splitting into training, validation, and test sets. During the training phase, the generative AI model 206 learns to recognize patterns within warehouse operations, such as typical workflows and errors, and detects anomalies that could indicate underlying issues. The generative AI model 206 is also trained to identify both predefined errors and more subtle, unstructured anomalies, by analyzing labelled images and logs from warehouse processes. Once trained and evaluated for accuracy, precision, and recall, the model is deployed for real-time operation. Using this pre-trained knowledge, the generative AI model 216 can analyse the incoming data to form an initial hypothesis about what might be causing the process error. This hypothesis is critical to the root cause analysis, as it narrows down potential sources of error, enabling subsequent deeper analysis by identifying the most likely causal factors.

The DAG generation module 208 may further construct a directed acyclic graph (DAG) representing potential causal relationships among variables associated with the process error. In an embodiment, the variables are derived from the contextual data. In an embodiment, the DAG captures both direct and indirect causal dependencies among the variables, which are derived from the contextual data. In an embodiment, the DAG generation module 208 constructs the directed acyclic graph by combining manual input from the warehouse operator with automated discovery algorithms. The DAG generation module 208 uses a combination of manual input from the warehouse operator and automated discovery algorithms. The manual input ensures that expert knowledge of warehouse processes, such as known relationships between picking errors and packaging errors, is integrated into the graph. Meanwhile, the automated discovery algorithms employ machine learning techniques to reveal hidden or non-obvious causal connections in the dataset. These algorithms include constraint-based methods, such as PC or FCI, to find conditional independencies between variables, and score-based methods like GES (Greedy Equivalence Search), which evaluates different causal models to identify the one that best fits the data. Additionally, functional causal models (FCM), such as LINGAM, may be used when assuming that data follows linear or non-Gaussian distributions, further refining the graph's structure.

In an embodiment, the DAG generation module 208 combines manual construction with automated discovery through a hybrid approach. Initially, the automated system 100 generates a preliminary DAG based on data-driven insights. This graph is then reviewed by a warehouse operator, who provides feedback on its accuracy. Based on this feedback, the system 100 refines the DAG by adjusting the relationships within the graph using a reinforcement learning module, ensuring that future DAG constructions are even more precise. This iterative process allows the system 100 to continuously improve its understanding of causal relationships, enabling more accurate root cause analysis over time.

Once the DAG is constructed, visualization tools are used to represent the relationships between variables. Each node in the DAG corresponds to a specific variable, such as a process step or error, and the edges represent causal influences. This clear visual representation helps warehouse operators and analysts identify how errors propagate through the system 100 and pinpoint root causes effectively.

The root cause identification module 212 may further identify one or more root causes of the process error by applying statistical and machine learning techniques to the DAG to estimate strength and direction of causal relationships between the variables associated with the process error, using the structural causal model 210. In this embodiment, the process begins by assigning causal mechanisms to the relationships in the DAG. For example, exogenous variables such as external supplier delays or network outages-represent factors that influence the system 100 from the outside. Endogenous variables, such as inventory errors or incorrect picking, are influenced by other internal warehouse processes. These variables are formalized within the SCM to enable causal analysis.

The root cause identification module 212 employs a combination of automated and manual approaches for assigning causal mechanisms. Automated methods may use machine learning models, such as random forests or AutoML, for complex relationships, while simpler relationships might use basic models. Manual assignment may be necessary for critical variables, where domain knowledge from warehouse operators plays a key role. For instance, continuous variables like temperature or cycle time may use additive noise models, whereas classifier models may be used for categorical outcomes like error types or success/error of specific tasks.

Once the SCM is constructed, the root cause identification module applies statistical techniques to validate the strength and direction of the causal relationships within the graph. Techniques like back testing compare simulated data from the DAG against real-world observations to ensure that the model accurately replicates the errors and anomalies seen in the warehouse. Additionally, statistical tests are applied to verify that the identified causal directions align with the observed data. This step ensures the validity and consistency of the causal relationships and refines the model as needed.

After validation, the root cause identification module 212 performs root cause analysis (RCA) by tracing process errors through the causal relationships defined in the SCM. It identifies the origin points of errors by analyzing the direct and indirect effects of various variables. For instance, if an error occurs in the packing process, the system 100 can trace it back to earlier operations, such as picking or inventory mismanagement, pinpointing the root cause. Counterfactual analysis can also be conducted to simulate interventions, helping to understand how corrective actions at earlier stages could have prevented the error.

This root cause identification process is critical for taking effective corrective actions, improving operational efficiency, and preventing future process errors. By combining data-driven insights with expert knowledge, the root cause identification module provides a robust and adaptive tool for warehouse management systems (WMS).

The root cause validation module 214 may further validate the identified root causes by comparing results of the structured causal model against historical data and known outcomes. This module ensures that the root cause analysis (RCA) performed by the system 100 is accurate and consistent with past observations, thereby increasing confidence in the system's ability to identify true causal relationships. In an embodiment, the validation process begins by retrieving historical data related to similar errors, processes, and outcomes from the warehouse management system (WMS) or other relevant databases. This historical data provides a reference point for comparison. The root cause validation module 214 compares the causal pathways and identified root causes generated by the SCM with the actual historical events to see if the model accurately reproduces the conditions leading to past errors. For example, if a picking error was historically caused by incorrect bin labelling, the validation module will check if the SCM accurately identifies this variable as the root cause in similar current or past cases. The user interface module 216 may further display via the I/O device 108, the one or more root causes to a warehouse operator for review and feedback.

The operator feedback module 218 may further receive operator feedback indicating acceptance or rejection of each presented root cause via the I/O device 108. In an embodiment, after the system 100 has identified and validated the root cause of a process error using the structured causal model (SCM) and other analytical techniques, the identified root cause is presented to the operator for review. The operator is then prompted to provide feedback on whether they agree or disagree with the system's conclusions. For example, if the root cause of an inventory discrepancy is identified as a mispick during the picking process, the system 100 will display this information to the operator. The operator may accept the proposed root cause if it aligns with their experience or operational knowledge or reject it if they believe the system 100 has overlooked other contributing factors. The operator feedback module 218 records this input, allowing the system 100 to adjust its analysis accordingly. In the case of an accepted root cause, the system 100 may proceed with corrective actions or recommend process improvements. In contrast, if the operator rejects the presented root cause, the system 100 may prompt for additional details or feedback to help refine its analysis. The operator may provide additional insights, such as alternative root causes or explanations based on their practical understanding of the warehouse operations, which may not be fully captured by the system's automated analysis.

The reinforcement learning module 220 may further refine the structured causal model 210 based on the feedback received from the operator. In an embodiment, positive feedback reinforces the accuracy of identified root causes and negative feedback triggers model adjustments. In an embodiment, the reinforcement learning module 220 uses a reward-based mechanism to adjust the parameters of the structured causal model. In an embodiment, positive rewards may be assigned to accepted root causes and negative may be assigned to rejected root causes. The reinforcement learning module 220 is designed to further refine the structured causal model 210 based on feedback received from the warehouse operator. This feedback is provided through the operator feedback module 218 and plays a critical role in enhancing the system's learning and performance.

In an embodiment, when the operator accepts the root cause suggested by the system 100, this positive feedback acts as a confirmation that the structured causal model has accurately identified the error's origin. In response, the reinforcement learning module 220 assigns a positive reward to the causal relationships and parameters within the model that led to this correct conclusion. This positive reinforcement strengthens the accuracy of those identified causal links, effectively solidifying the model's understanding of that particular error scenario.

Conversely, when the operator rejects a suggested root cause, indicating that the system 100 has misidentified the error's origin, the reinforcement learning module assigns a negative reward. This triggers a series of adjustments to the structured causal model. The system 100 reevaluates the relationships within the directed acyclic graph (DAG) and reconfigures the parameters of the causal model to minimize the likelihood of repeating the same error. The adjustments may involve recalibrating the strength of certain causal dependencies, introducing new data-driven insights, or refining the underlying algorithms responsible for discovering causal relationships.

In an embodiment, the reinforcement learning module 220 operates using a reward-based mechanism, where each feedback instance directly influences the system's future predictions. Accepted root causes yield positive rewards, reinforcing the model's confidence in its current structure and promoting similar predictions in the future. On the other hand, rejected root causes lead to negative rewards, signalling the need for adjustments. Over time, the system 100 fine-tunes itself, becoming more adept at identifying accurate root causes by learning from its mistakes and successes.

This continuous feedback loop allows the system 100 to self-learn and evolve with each error analysis session. As the operator provides feedback, the reinforcement learning module integrates this new information, ensuring that the model becomes increasingly effective at root cause identification. Additionally, the system 100 may compare newly adjusted models with previous versions to ensure that modifications lead to overall performance improvements.

The knowledge database module 222 may further store the operator input, and a corresponding reasoning in the knowledge database 114. In an embodiment, the knowledge database 114 may be used for future predictions and analysis. In an embodiment, the knowledge database 114 may store a history of errors, accepted root causes, rejected root causes, and model refinements. The knowledge database module 222 is responsible for storing operator input and the corresponding reasoning in the knowledge database 114. This stored information forms a critical part of the system's evolving knowledge base, contributing to improved accuracy and efficiency in future error predictions and analyses.

In an embodiment, the knowledge database 114 may be used for future predictions by allowing the system 100 to reference past operator feedback and the reasoning behind accepted or rejected root causes. This historical data provides a rich source of insights that the system 100 can leverage to make more informed predictions about similar errors in the future. By referencing past patterns and outcomes, the system 100 enhances its ability to identify root causes more accurately over time.

In an embodiment, the knowledge database 114 may also store a detailed history of errors encountered during warehouse operations, including the suggested root causes provided by the system 100 and the operator's feedback. This history would record both accepted and rejected root causes, along with the associated reasoning provided by the operator. By maintaining this comprehensive error log, the system 100 can track how its model has performed over time, including any model refinements made as a result of operator feedback.

The error report generation module 224 may further generate an error report summarizing the root causes, operator feedback, and model adjustments for review by a warehouse management team. In an embodiment, the error report includes a detailed breakdown of the identified root causes for each process error. This section of the report outlines the results from the structured causal model 210, highlighting the causal relationships determined by the system 100 and ranking the most likely root causes based on the strength of these relationships. This provides the management team with clear insights into the underlying factors contributing to errors within the warehouse operations.

The report also captures the operator's feedback, including whether each root cause was accepted or rejected. The operator's reasoning for each decision may be documented, offering the management team a valuable perspective on how well the system's suggestions align with the operator's real-world experience. This feedback loop is critical for understanding the accuracy of the AI-driven root cause analysis and for validating the system's effectiveness in identifying errors. Furthermore, the report details any adjustments made to the structured causal model 210 by the reinforcement learning module 220 in response to operator feedback. If the operator rejected any suggested root causes, the system's modifications to refine its model are noted, including changes in the parameters or causal relationships. This ensures that the warehouse management team is fully informed about how the system 100 is evolving and learning from feedback, thus becoming more accurate over time. In an embodiment, the error report also includes key performance indicators (KPIs) to evaluate the system's performance, such as the accuracy of root cause identification, the rate of operator agreement, and the frequency of model adjustments. These metrics provide the warehouse management team with a data-driven assessment of the system's efficiency and its impact on warehouse operations.

The corrective action recommendation module 226 may further recommend corrective actions to the warehouse operator based on the identified root causes and the historical data stored in the knowledge database 114. This module leverages the insights generated from the root cause analysis and the system's accumulated knowledge to provide actionable guidance aimed at resolving process errors and improving warehouse efficiency.

In an embodiment, the corrective action recommendation module 226 analyses the identified root causes from the structured causal model 210 to determine the most appropriate actions that can directly address the error. By mapping each root cause to a specific set of corrective actions, the corrective action recommendation module 226 ensures that the recommendations are tailored to the particular issue, whether it involves a procedural, human, or system-related factor. In addition to current error analysis, the corrective action recommendation module 226 draws upon the knowledge database 114, which stores a rich history of past errors, accepted and rejected root causes, and previous corrective actions taken. This historical data enables the system 100 to identify patterns and trends, ensuring that the recommended actions are both informed by past experience and optimized for effectiveness. For example, if a similar error has occurred before and a certain corrective action successfully resolved it, the module will prioritize that action for the current situation.

In an embodiment, the recommended corrective actions are displayed to the warehouse operator via the I/O device 108, providing clear and actionable guidance. These recommendations may be categorized by urgency, potential impact, and the resources required for implementation. This helps the operator make informed decisions about which actions to prioritize in order to minimize disruptions and improve process outcomes.

The corrective action recommendation module 226 may also suggest preventive actions to mitigate the recurrence of similar errors in the future. For example, if an analysis of past errors indicates that certain types of errors frequently occur during the picking process, the module may recommend enhancements to the picking protocol, additional training for operators, or system configuration adjustments. These preventive measures are crucial for reducing the likelihood of future errors and improving overall warehouse performance.

In some embodiments, the corrective action recommendation module 226 integrates with other warehouse management systems (WMS, WCS, etc.) to automatically implement the corrective actions, streamlining the process of error resolution. This integration can help the system autonomously trigger updates, adjust workflows, or initiate repairs based on the identified root causes and the corrective actions chosen by the operator.

The action tracking and learning module 228 is designed to monitor the implementation of corrective actions recommended by the system and track their outcomes. This action tracking and learning module 228 ensures continuous learning and improvement by assessing the effectiveness of actions and feeding the results back into the system for refinement. After the corrective action recommendation module 226 suggests actions, the action tracking and learning module 228 monitors their execution and evaluates their impact on resolving the identified error. For example, if a corrective action involves recalibrating a weighing scale, this module tracks whether the recalibration was performed, when it was completed, and whether it resolved the weight discrepancy error.

The action tracking and learning module 228 analyses post-corrective action data to assess whether the recommended action successfully addressed the root cause. For example, it evaluates if inventory errors decreased after implementing additional training for pickers. If an action fails to resolve the issue or introduces new errors, this is flagged for further analysis. The action tracking and learning module 228 records all actions taken, their outcomes, and operator feedback into the knowledge database 114. This creates a rich historical dataset for future reference, enabling the system to learn from past interventions. For example, if a particular corrective action consistently resolves a specific error type, the system prioritizes this action in similar future scenarios. The action tracking and learning module 228 identifies patterns in corrective actions and their outcomes. For instance, it might discover that errors in the picking process frequently arise during high traffic periods and suggest schedule adjustments to mitigate them. By analyzing trends over time, the system can proactively recommend process improvements even before errors occur.

The action tracking and learning module 228 also collaborates with the reinforcement learning module 220 to refine the system's decision-making process. Successful corrective actions are rewarded, reinforcing their prioritization, while ineffective actions trigger adjustments to the structured causal model. For instance, if a corrective action involving software updates for scanning devices consistently resolves scanning errors, the system “learns” to recommend similar updates pre-emptively. The action tracking and learning module 228 generates detailed reports summarizing the actions taken, their outcomes, and insights gained. These reports are shared with warehouse operators and management teams for further decision-making. Based on tracked actions and their success rates, the action tracking and learning module 228 provides preventive recommendations to reduce the likelihood of recurring errors. For example, it might suggest routine maintenance schedules for devices with frequent malfunction histories.

By integrating real-time monitoring, historical learning, and predictive analysis, the action tracking and learning module 228 ensures the system evolves continuously, becoming more effective at identifying and resolving errors in warehouse operations. The action tracking and learning module 228, in conjunction with others, establishes a feedback-rich, self-improving framework for efficient warehouse management.

It should be noted that all such aforementioned modules 202-228 may be represented as a single module or a combination of different modules. Further, as will be appreciated by those skilled in the art, each of the modules 202-228 may reside, in whole or in parts, on one device or multiple devices in communication with each other. In some embodiments, each of the modules 202-228 may be implemented as dedicated hardware circuit comprising custom application-specific integrated circuit (ASIC) or gate arrays, off-the-shelf semiconductors such as logic chips, transistors, or other discrete components. Each of the modules 202-228 may also be implemented in a programmable hardware device such as a field programmable gate array (FGPA), programmable array logic, programmable logic device, and so forth. Alternatively, each of the modules 202-228 may be implemented in software for execution by various types of processors (e.g. processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for performing root cause analysis in the warehouse management system. For example, the exemplary system 100 and the associated computing device 102 may perform the root cause analysis by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

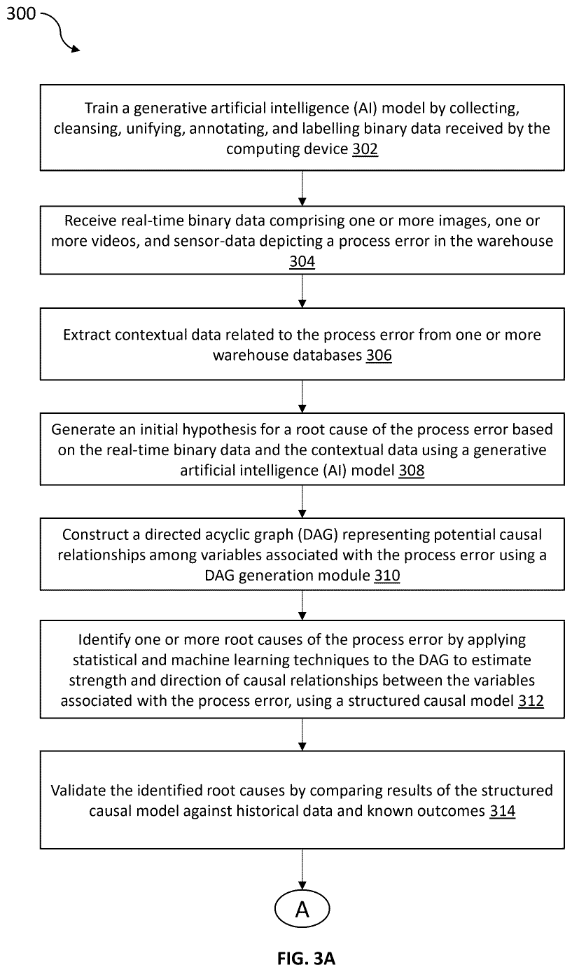

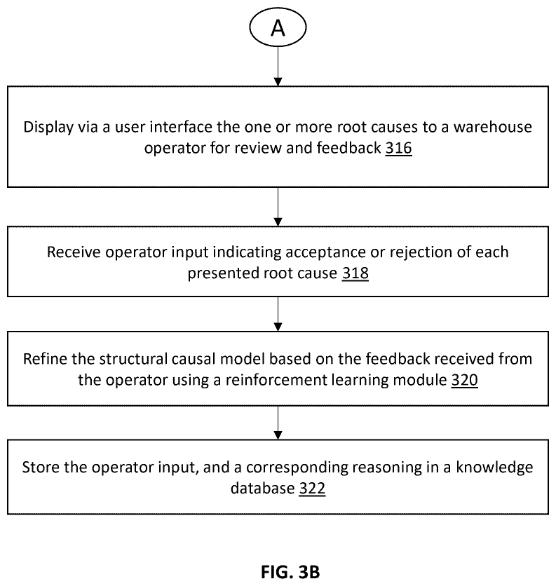

Referring now to FIG. 3A and FIG. 3B, a flow diagram 300 of a methodology for performing root cause analysis in a warehouse management system, is illustrated, in accordance with an embodiment of present disclosure. FIG. 3A and FIG. 3B is explained in conjunction with FIG. 1 and FIG. 2. In an embodiment, the flow diagram 300 may include a plurality of steps that may be performed by various modules of the computing device 102 so as to perform root cause analysis in the warehouse management system.

At step 302, the computing device 102 may train a generative artificial intelligence (AI) model 206 by collecting, cleansing, unifying, annotating, and labelling binary data received by the computing device 102. In an embodiment, the binary data comprising one or more images, one or more videos, sensor data, and system data depicting a comprehensive data of both successful and error data in the warehouse. In an embodiment, the generative AI model 206 is trained based on the labelled binary data.

At step 304, the computing device 102 may receive real-time binary data that may include one or more images, one or more videos, and sensor-data depicting a process error in the warehouse. In an embodiment, the real-time binary data may also include error screenshots and videos captured by the warehouse operator. In an embodiment, the real-time binary data may be captured in real-time and/or from archived records.

Further at step 306, the computing device 102 may further extract contextual data related to the process error from one or more warehouse databases. In an embodiment, the contextual data may include package information, picking information, device data, process data, human factors, environmental data, historical anomaly data, customer feedback data, and operator-captured screenshots and videos. In an embodiment, the contextual data may include customer feedback data, including customer complaints, return reasons, and customer satisfaction scores. The package information may include package ID, SKU, weight, and destination. The picking information may include picker ID, bin location, picked quantity, and pick status. The device data may include device type, device ID, device status, and error logs. The process data may include expected and actual values at each process step, cycle time and resolution action taken. The human factors may include operator ID, experience level, shift ID, and staffing level. The environmental data may include temperature, humidity, and warehouse traffic levels.

Further at step 308, the computing device 102 may further generate an initial hypothesis for a root cause of the process error based on the real-time binary data and the contextual data using the generative AI model 206. Further at step 310, the computing device 102 may further construct a directed acyclic graph (DAG) representing potential causal relationships among variables associated with the process error using a DAG generation module 208. In an embodiment, the variables are derived from the contextual data. In an embodiment, the DAG captures both direct and indirect causal dependencies among the variables, which are derived from the contextual data. In an embodiment, the DAG generation module 208 constructs the directed acyclic graph by combining manual input from the warehouse operator with automated discovery algorithms.

Further at step 312, the computing device 102 may further identify one or more root causes of the process error by applying statistical and machine learning techniques to the DAG to estimate strength and direction of causal relationships between the variables associated with the process error, using a structural causal model. Further at step 314, the computing device 102 may further validate the identified root causes by comparing results of the structured causal model against historical data and known outcomes.

Further at step 316, the computing device 102 may further display via the I/O device 108, the one or more root causes to a warehouse operator for review and feedback. Further at step 318, the computing device 102 may further receive operator input indicating acceptance or rejection of each presented root cause. Further at step 320, the computing device 102 may further refine the structured causal model based on the feedback received from the operator using a reinforcement learning module. In an embodiment, positive feedback reinforces the accuracy of identified root causes and negative feedback triggers model adjustments. In an embodiment, the reinforcement learning module uses a reward-based mechanism to adjust the parameters of the structured causal model. In an embodiment, positive rewards may be assigned to accepted root causes and negative may be assigned to rejected root causes.

Further at step 322, the computing device 102 may further store the operator input, and a corresponding reasoning in the knowledge database 114. In an embodiment, the knowledge database 114 may be used for future predictions and analysis. In an embodiment, the knowledge database 114 may store a history of errors, accepted root causes, rejected root causes, and model refinements. The computing device 102 may further generate an error report summarizing the root causes, operator feedback, and model adjustments for review by a warehouse management team. The computing device 102 may further recommend corrective actions to the warehouse operator based on the identified root causes and the historical data stored in the knowledge database 114.

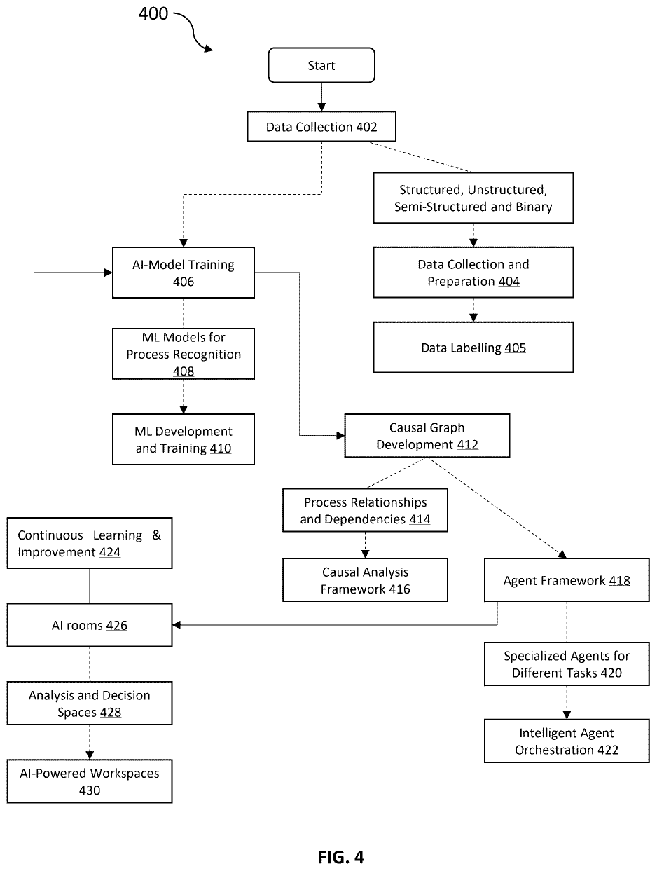

Referring now to FIG. 4, a detailed flow diagram 400 of a methodology for performing root cause analysis in a warehouse management system, is illustrated, in accordance with an exemplary embodiment of present disclosure. FIG. 4 is explained in conjunction with FIGS. 1-3. In an embodiment, the flow diagram 400 may include a plurality of steps that may be performed by various modules of the computing device 102 so as to perform root cause analysis in the warehouse management system.

The process begins with Data Collection 402, where structured, unstructured, semi-structured, and real-time binary data is gathered. The collected data undergoes Data Collection and Preparation 404, where the collected data is processed and organized into a format suitable for AI model training and analysis. The prepared data feeds into AI-Model Training 406, which utilizes machine learning techniques to recognize and analyse warehouse processes. This stage involves ML Models for Process Recognition 408 that are used to detect patterns of success and error occurrences within the warehouse operations. These models are further developed and refined in ML Development and Training 410, enhancing the system's ability to predict and analyse errors.

Once the models are trained, the process moves to Causal Graph Development 412, where the system constructs a Directed Acyclic Graph (DAG) to map out the causal relationships between variables associated with process errors. The DAG is crucial in understanding both direct and indirect dependencies between processes. The relationships between these variables are defined and visualized in Process Relationships and Dependencies 414, where the structure of how different warehouse activities influence each other is established. Using the DAG, the system 100 engages in a Causal Analysis Framework 416, which is responsible for estimating the strength and direction of these causal relationships. The analysis of these relationships allows for the identification of root causes of process errors. The results of this analysis are critical in enabling targeted interventions to resolve or prevent future errors.

The flow proceeds to an Agent Framework 418, where specialized agents are deployed to perform different tasks within the system 100. The framework includes Specialized Agents for Different Tasks 420, each dedicated to specific areas such as process monitoring, error detection, or intervention. These agents work in collaboration under Intelligent Agent Orchestration 422, ensuring smooth coordination and decision-making across various warehouse processes. A core aspect of the methodology is Continuous Learning & Improvement 424, which ensures that the AI model is constantly evolving. The system 100 receives feedback, adjusts its parameters, and improves its accuracy over time, based on ongoing interactions with operators and the environment. The system 100 operates within AI rooms 426, which are virtual environments designed for real-time error analysis and decision-making. These AI rooms are supported by Analysis and Decision Spaces 428, where operators can review data, root causes, and model suggestions before taking corrective action. Finally, the workflow culminates in AI-Powered Workspaces 430, where all the information is synthesized to provide actionable insights and suggestions to the warehouse management team.

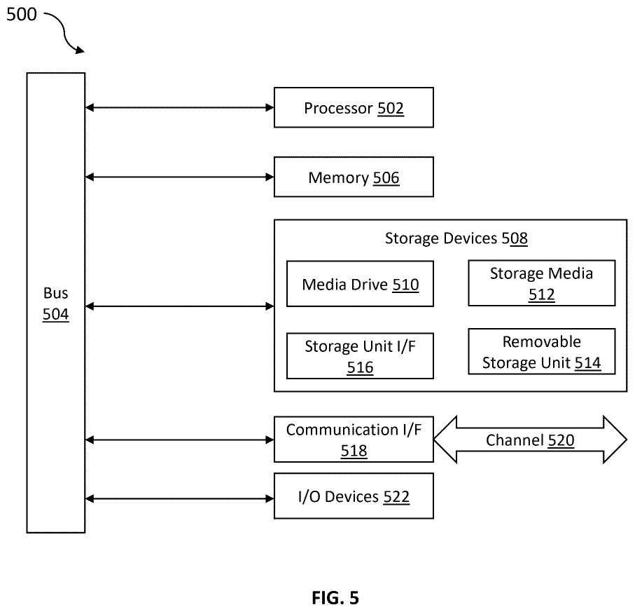

Referring now to FIG. 5, an exemplary computer system 500 for implementation of a method for performing root cause analysis in a warehouse management system, is illustrated, in accordance with an exemplary embodiment of present disclosure.

Those skilled in the relevant art will also recognize how to implement the invention using other computer systems or architectures. The computing system 500 may represent, for example, an end device that involves network connection. In an embodiment, the end device may include, but not limited to a smart phone, a laptop computer, a desktop computer, a workstation, a portable computer, a handheld, or a mobile device. In an embodiment, the computing system 500 may represent, for example, an end-device with the provision of mobility. Examples of the end-device with the provision of mobility may include but not limited to a Telematics Control Unit (TCU), an infotainment system, a Vehicle-to-Everything Device (V2X) device, an On-board Diagnostics Device (OBD), an Advanced Driver Assistance Systems (ADAS) sensor, and the like. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication medium. In an embodiment, examples of processor 502 may include, but are not limited to, microcontrollers, microprocessors, digital signal processors (DSPs), application-specific integrated circuits (ASICs), field-programmable gate arrays (FPGAs), system-on-chip (SoC) components, or any other suitable programmable logic devices, system-on-a-chip processors or other future processors.

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage devices 508, which may include, for example, a media drive 510 and a removable storage interface 514. The media drive 510 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 912 may include, for example, a hard disk, magnetic tape, flash drive, or other fixed or removable medium that is read by and written to by the media drive 510. As these examples illustrate, the storage media 512 may include a computer-readable storage medium having stored there in particular computer software or data.

In alternative embodiments, the storage devices may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro-USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or another communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

Thus, the disclosed method 300 and system 100 overcome the challenges associated with conventional root cause analysis (RCA) methods in warehouse management systems by introducing a robust, AI-driven approach. Traditional methods often rely on manual data analysis, which is time-consuming, error-prone, and limited in scope. The following key improvements offered by the disclosed system 100 address these shortcomings:

The system 100 collects a wide variety of data in real-time, including real-time binary data (images, videos, sensor data) and contextual data (package information, device logs, human factors, etc.). This automated data capture eliminates the need for manual data entry and ensures a comprehensive analysis that incorporates all relevant variables. Traditional systems typically require manual input, which can overlook crucial data points. By utilizing artificial intelligence, the system 100 can automatically generate initial hypotheses regarding the root causes of warehouse errors. This feature drastically reduces the time needed for RCA and increases the accuracy of the initial analysis. Conventional methods often depend on human experience and intuition, which may lead to biases or misinterpretations of data. The system 100 constructs a directed acyclic graph (DAG) to represent potential causal relationships between variables. This structure captures both direct and indirect influences, enabling the system to analyze complex interactions among multiple factors (e.g., device malfunctions, human errors, environmental conditions). Traditional approaches often analyse each factor in isolation, failing to account for the interplay between different variables. By applying advanced machine learning and statistical methods to the DAG, the system identifies root causes with high precision. This technique allows the system to handle large datasets and uncover subtle, non-obvious patterns that might be missed by human analysts. In contrast, conventional methods typically involve simpler statistical analyses that may not fully leverage the available data. The system incorporates reinforcement learning, allowing it to refine its causal models based on feedback from warehouse operators. Positive feedback reinforces accurate root cause identifications, while negative feedback prompts adjustments to the model. This feedback loop enables the system to improve over time, something that traditional RCA methods cannot easily achieve without extensive reconfiguration.

The system stores all data, including root causes, feedback, and model adjustments, in the knowledge database 114. This historical record allows the system to make more accurate predictions and analyses in the future by learning from past mistakes and successful interventions. Conventional systems typically do not have this level of long-term, self-learning capabilities. The system 100 generates detailed error reports that summarize the identified root causes, operator feedback, and any corrective actions. These reports are generated in real-time, providing warehouse operators and management teams with actionable insights that can be immediately implemented to resolve issues. Traditional RCA methods often produce delayed reports that may not provide actionable insights in a timely manner.

The disclosed method 300 and system 100 overcome the limitations of conventional RCA systems by automating data collection, employing advanced AI techniques, providing continuous model improvement, and offering real-time, actionable insights. This leads to faster, more accurate root cause analysis and enables warehouses to optimize their operations more effectively, reduce errors, and enhance overall productivity.

As will be appreciated by those skilled in the art, the techniques described in the various embodiments discussed above are not routine, or conventional, or well-understood in the art. The techniques discussed above provide for analysing an equipment for current cycling test.

In light of the above-mentioned advantages and the technical advancements provided by the disclosed method 300 and system 100, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A computer-implemented method for performing root cause analysis in a warehouse management system using artificial intelligence, comprising:
training, by a computing device, a generative artificial intelligence (AI) model by collecting, cleansing, unifying, annotating, and labelling binary data received by the computing device, wherein the binary data comprising one or more images, one or more videos, sensor data, and system data depicting a comprehensive data of both successful and error data in the warehouse, wherein the generative AI model is trained based on the labelled binary data;
receiving, by a computing device, real-time binary data comprising one or more images, one or more videos, sensor-data, and system data depicting a process error in the warehouse, wherein the real-time binary data is captured in real-time and/or from archived records;
extracting, by the computing device, contextual data related to the process error from one or more warehouse databases, trained/labelled data related to historical process execution comprising both success and error, wherein the contextual data comprising package information, warehouse process related information, packing information, quality check information, device data, process data, human factors, environmental data, historical anomaly data, customer feedback data, and operator-captured screenshots and videos;
pre-processing, by the computing device, the real-time binary data by cleaning, unifying, annotating, and labelling the received real-time binary data;
generating, by the computing device, an initial hypothesis for a root cause of the process error based on the real-time binary data and the contextual data using the generative AI model;
constructing, by the computing device, a directed acyclic graph (DAG) representing potential causal relationships among variables associated with the process error using a DAG generation module, wherein the variables are derived from the contextual data, wherein the DAG captures both direct and indirect causal dependencies among the variables, which are derived from the contextual data and historical trained data;
identifying, by the computing device, one or more root causes of the process error by applying statistical and machine learning and advanced Artificial Intelligence (AI) techniques to the DAG to estimate strength and direction of causal relationships between the variables associated with the process error, using a structured causal model; and
validating, by the computing device, the identified root causes by comparing results of the structured causal model against historical data and known outcomes.

2. The computer-implemented method of claim 1, further comprising:
displaying, by the computing device and via a user interface, the one or more root causes to a warehouse operator for review and feedback;
receiving, by the computing device, operator feedback indicating acceptance or rejection of each presented root cause;
refining, by the computing device, the structured causal model based on the feedback received from the operator using a reinforcement learning module, wherein positive feedback reinforces the accuracy of identified root causes and negative feedback triggers model adjustments; and
storing, by the computing device, the operator feedback, and a corresponding reasoning in a knowledge database, wherein the knowledge database is used for future predictions and analysis.

3. The computer-implemented method of claim 1, wherein the real-time binary data comprises error screenshots and videos captured by the warehouse operator.

4. The computer-implemented method of claim 1, wherein the contextual data further comprises customer feedback data, including customer complaints, reasons, and customer satisfaction scores.

5. The computer-implemented method of claim 1, wherein the DAG generation module constructs the directed acyclic graph by combining manual input from the warehouse operator with automated discovery algorithms.

6. The computer-implemented method of claim 2, wherein the reinforcement learning module uses a reward-based mechanism to adjust the parameters of the structured causal model, wherein positive rewards are assigned to accepted root causes and negative rewards are assigned to rejected root causes.

7. The computer-implemented method of claim 2, wherein the knowledge database stores a history of errors, accepted root causes, rejected root causes, action taken, applied resolution, expected outcome, observed outcome, and model refinements.

8. The computer-implemented method of claim 1, further comprising generating, by the computing device, an error report summarizing the root causes, operator feedback, and model adjustments for review by a warehouse management team.

9. The computer-implemented method of claim 1, wherein the contextual data comprises:
package information comprising package ID, SKU, weight, and destination;
warehouse process related information comprising picker ID, bin location, picked quantity, and pick status;
device data comprising device type, device ID, device status, and error logs;
process data comprising expected and actual values at each process step, cycle time, and resolution actions taken;
human factors data comprising operator ID, experience level, shift ID, and staffing level; and
environmental data comprising temperature, humidity, and warehouse traffic levels.

10. The computer-implemented method of claim 1, further comprising recommending, by the computing device, corrective actions to the warehouse operator based on the identified root causes and historical data stored in the knowledge database.

11. A computer-implemented system for performing root cause analysis in a warehouse management system using artificial intelligence, the computer-implemented system comprising:
a computing device comprising:
a processor; and
a memory communicably coupled to the processor, wherein the memory stores processor-executable instructions, which when executed by the processor, cause the processor to:
train a generative artificial intelligence (AI) model by collecting, cleansing, unifying, annotating, and labelling binary data received by the computing device, wherein the binary data comprising one or more images, one or more videos, sensor data, and system data depicting a comprehensive data of both successful and error data in the warehouse, wherein the generative AI model is trained based on the labelled binary data;
receive real-time binary data comprising one or more images, one or more videos, sensor-data and system data depicting a process error in the warehouse, wherein the real-time binary data is captured in real-time and/or from archived records;
extract contextual data related to the process error from one or more warehouse databases, trained/labelled data related to historical process execution comprising both success and error, wherein the contextual data comprising package information, warehouse process related information, packing information, quality check information, device data, process data, human factors, environmental data, historical anomaly data, customer feedback data, and operator-captured screenshots and videos;
pre-process the real-time binary data by cleaning, unifying, annotating, and labelling the received real-time binary data;
generate an initial hypothesis for a root cause of the process error based on the real-time binary data and the contextual data using a generative artificial intelligence (AI) model;
construct a directed acyclic graph (DAG) representing potential causal relationships among variables associated with the process error using a DAG generation module, wherein the variables are derived from the contextual data and historical trained data, wherein the DAG captures both direct and indirect causal dependencies among the variables, which are derived from the contextual data;
identify one or more root causes of the process error by applying statistical and machine learning and advanced Artificial Intelligence (AI) techniques to the DAG to estimate strength and direction of causal relationships between the variables associated with the process error, using a structured causal model; and
validate the identified root causes by comparing results of the structured causal model against historical data and known outcomes.

12. The computer-implemented system of claim 11, wherein the processor-executable instructions further cause the processor to:
display via a user interface the one or more root causes to a warehouse operator for review and feedback;
receive operator feedback indicating acceptance or rejection of each presented root cause;
refine the structured causal model based on the feedback received from the operator using a reinforcement learning module, wherein positive feedback reinforces the accuracy of identified root causes and negative feedback triggers model adjustments; and
store the operator feedback, and a corresponding reasoning in a knowledge database, wherein the knowledge database is used for future predictions and analysis.

13. The computer-implemented system of claim 11, wherein the real-time binary data comprises error screenshots and videos captured by the warehouse operator, and
wherein the contextual data further comprises customer feedback data, including customer complaints, return reasons, and customer satisfaction scores.

14. The computer-implemented system of claim 11, wherein the DAG generation module constructs the directed acyclic graph by combining manual input from the warehouse operator with automated discovery algorithms.

15. The computer-implemented system of claim 12, wherein the reinforcement learning module uses a reward-based mechanism to adjust the parameters of the structured causal model, wherein positive rewards are assigned to accepted root causes and negative rewards are assigned to rejected root causes.

16. The computer-implemented system of claim 12, wherein the knowledge database stores a history of errors, accepted root causes, rejected root causes, and model refinements.

17. The computer-implemented system of claim 11, wherein the processor-executable instructions further cause the processor to:
generate an error report summarizing the root causes, operator feedback, and model adjustments for review by a warehouse management team.

18. The computer-implemented system of claim 11, wherein the contextual data comprises:
package information comprising package ID, SKU, weight, and destination;
warehouse process related information comprising picker ID, bin location, picked quantity, and pick status;
device data comprising device type, device ID, device status, and error logs;
process data comprising expected and actual values at each process step, cycle time, and resolution actions taken;
human factors data comprising operator ID, experience level, shift ID, and staffing level; and
environmental data comprising temperature, humidity, and warehouse traffic levels.

19. The computer-implemented system of claim 11, wherein the processor-executable instructions further cause the processor to:
recommend corrective actions to the warehouse operator based on the identified root causes and historical data stored in the knowledge database.

20. A non-transitory computer-readable medium storing computer-executable instructions for performing root cause analysis in a warehouse management system using artificial intelligence, the computer-executable instructions configured for:
training a generative artificial intelligence (AI) model by collecting, cleansing, unifying, annotating, and labelling binary data received by the computing device, wherein the binary data comprising one or more images, one or more videos, sensor data, and system data depicting a comprehensive data of both successful and error data in the warehouse, wherein the generative AI model is trained based on the labelled binary data;
receiving real-time binary data comprising one or more images, one or more videos, sensor-data and system data depicting a process error in the warehouse, wherein the real-time binary data is captured in real-time and/or from archived records;
extracting contextual data related to the process error from one or more warehouse databases, wherein the contextual data comprising package information, warehouse process related information, packing information, quality check information, device data, process data, human factors, environmental data, historical anomaly data, customer feedback data, and operator-captured screenshots and videos;
pre-processing the real-time binary data by cleaning, unifying, annotating, and labelling the received real-time binary data;
generate an initial hypothesis for a root cause of the process error based on the real-time binary data and the contextual data using a generative artificial intelligence (AI) model;
construct a directed acyclic graph (DAG) representing potential causal relationships among variables associated with the process error using a DAG generation module, wherein the variables are derived from the contextual data, wherein the DAG captures both direct and indirect causal dependencies among the variables, which are derived from the contextual data;
identify one or more root causes of the process error by applying statistical and machine learning techniques to the DAG to estimate strength and direction of causal relationships between the variables associated with the process error, using a structured causal model; and validate the identified root causes by comparing results of the structured causal model against historical data and known outcomes.
